(19) United States
(12) Patent Application Publication
(10) Pub. No.: US 2025/0231380 A1
(43) Pub. Date: Jul. 17, 2025

(54) CAMERA MODULE

(71) Applicant: SAMSUNG ELECTRO-MECHANICS CO., LTD., Suwon-si (KR)

(72) Inventors: So Mi YANG, Suwon-si (KR); Ho Bin GO, Suwon-si (KR); Jin Se KIM, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 18/958,351

(22) Filed: Nov. 25, 2024

(30) Foreign Application Priority Data
Jan. 16, 2024 (KR) 10-2024-0006934

(51) Int. Cl. G02B 13/00; G03B 17/12; H04N 23/55

(52) U.S. Cl. CPC G02B 13/0045; G02B 13/0065; G03B 17/12; H04N 23/55

(57) ABSTRACT

A camera module including a first lens group having a plurality of lenses and disposed fixedly on an optical axis, and a second lens group having a plurality of lenses and movable in an optical axis direction, wherein the first lens group and the second lens group are disposed in sequence from an object side. A distance on the optical axis from an object-side surface of a lens of the second lens group, disposed closest to the object side, to an image-side surface of a lens of the second lens group, disposed closest to an image side is shorter than a distance on the optical axis from an object-side surface of a lens of the first lens group, disposed closest to the object-side, to an image-side surface of a lens of the first lens group, disposed closest to the image side.

### CROSS-REFERENCE TO RELATED APPLICATIONS

This application claims the benefit under 35 USC 119 (a) of Korean Patent Application No. 10-2024-0006934 filed on Jan. 16, 2024, in the Korean Intellectual Property Office, the entire disclosure of which is incorporated herein by reference for all purposes.

### BACKGROUND

### 1. Field

The present disclosure relates to a camera module capable of performing macrophotography.

### 2. Description of the Background

Smartphones may include both wide-angle cameras and telephoto cameras having different optical properties.

It is common to use a wide-angle lens having a short focal length when an image of a subject is captured at a close distance using a smartphone. However, due to properties of a camera, when the image of the subject at a close distance is captured using a telephoto camera having a long focal length, the surroundings of the subject may be blurred and the image of the subject may stand out, such that an image having a quality more suitable for a close-up condition may be obtained.

Instead, a telephoto camera may have a long focal length, such that a driving distance required for focusing when an image of a subject is captured at a close distance may be inevitably increased, resulting in an increase in a length of a camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first lens group having a plurality of lenses and disposed fixedly on an optical axis, and a second lens group having a plurality of lenses and movable in an optical axis direction, wherein the first lens group and the second lens group are disposed in sequence from an object side, and wherein a distance on the optical axis from an object-side surface of a lens of the second lens group, disposed closest to the object side, to an image-side surface of a lens of the second lens group, disposed closest to an image side, is shorter than a distance on the optical axis from an object-side surface of a lens of the first lens group, disposed closest to the object side, to an image-side surface of a lens of the first lens group, disposed closest to the image side.

The camera module may further include an image sensor disposed on the image side of the second lens group, wherein the second lens group may be configured to be movable in the optical axis direction between the first lens group and the image sensor.

An optical axis of the first lens group and an optical axis of the second lens group may approximately correspond to each other.

The first lens group may be accommodated in a first lens barrel, and the second lens group may be accommodated in a second lens barrel.

The camera module may further include an optical path converter disposed on the object side of the first lens group.

The optical path converter may be configured to be rotatable about one or more of the optical axis, a first axis perpendicular to the optical axis, and a second axis perpendicular to both the optical axis and the first axis.

The camera module may further include a third lens group including a plurality of lenses and movable in an optical axis direction, wherein the third lens group may be disposed on the image side of the second lens group.

One or more of the first lens group and the second lens group may include a D-cut lens having a straight portion on an edge thereof.

One or more of the first lens group and the second lens group may include three or more lenses.

A portable electronic device may include the camera module, wherein the optical axis direction may be perpendicular to a thickness direction of the portable electronic device.

A portable electronic device may include a plurality of camera modules having different optical characteristics from each other, wherein the plurality of camera modules may include the camera module.

In another general aspect, a camera module includes a first lens group including some lenses, among five or more lenses arranged in an optical axis direction, and a second lens group including the remaining lenses. The second lens group is configured to be movable relative to the first lens group in the optical axis direction. A distance on the optical axis from an object-side surface of a lens of the second lens group, disposed closest to an object side, to an image-side surface of a lens of the second lens group, disposed closest to an image side, is shorter than a distance on the optical axis from an object-side surface of a lens of the first lens group, disposed closest to the object side, to an image-side surface of a lens of the first lens group, disposed closest to the image side.

Each of the first lens group and the second lens group may include two or more lenses.

The first lens group may be disposed on the object side of the second lens group, and an image sensor may be disposed on the image side of the second lens group.

One or more of the five or more lenses may include a D-cut lens having a straight portion on an edge thereof.

The five or more lenses may be formed of a glass or plastic material.

The camera module may further include a first lens barrel in which the first lens group may be mounted, a second lens barrel in which the second lens group may be mounted, and a housing in which the first lens barrel and the second lens barrel may be accommodated, wherein the first lens barrel may have a plurality of rib surfaces coupled to the housing.

Other features and aspects will be apparent from the following detailed description, the drawings, and the claims.

### BRIEF DESCRIPTION OF DRAWINGS

FIG. 1 is a perspective view of a portable electronic device including a camera module mounted thereon according to an example embodiment of the present disclosure.

FIG. 2A is a schematic block diagram (infinite focus mode) of a camera module according to an example embodiment of the present disclosure.

FIG. 2B is a schematic block diagram (macro focus mode) of a camera module according to an example embodiment of the present disclosure.

FIG. 3 is a diagram illustrating a configuration of a lens according to an example embodiment of the present disclosure.

FIG. 4 is a diagram illustrating a height of a camera module according to an example embodiment of the present disclosure.

FIG. 5 is a diagram illustrating an example embodiment in which a first lens is provided as a D-cut lens according to an example embodiment of the present disclosure.

FIG. 6 is an example diagram illustrating a first lens barrel according to an example embodiment of the present disclosure.

FIGS. 7A and 7B are example diagrams illustrating driving of an optical path converter of a camera module according to an example embodiment of the present disclosure.

FIGS. 8A and 8B are example diagrams illustrating driving of an optical path converter of a camera module according to another example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure provides a camera module capable of capturing an image of a subject at ultra-close distance.

More specifically, the present disclosure provides a camera module having a reduced amount of driving required for capturing an image of a subject at ultra-close distance in a telephoto camera.

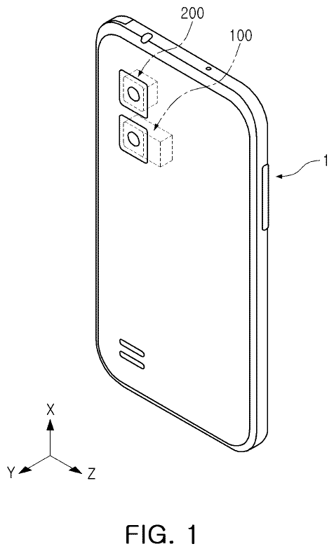

FIG. 1 is a perspective view of a portable electronic device including a camera module mounted thereon according to an example embodiment of the present disclosure.

In an example embodiment, a portable electronic device 1 may be a smartphone, or may be other types of mobile communication terminals, such as a tablet PC, or the like.

A plurality of camera modules 100 and 200 may be mounted on the portable electronic device 1 to capture an image of a subject.

A plurality of camera modules 100 and 200 may have different optical characteristics from each other. For example, the plurality of camera modules 100 and 200 may include a first camera module 100 having a relatively long focal length and a narrow angle of view, and a second camera module 200 having a relatively short focal length and a wide angle of view.

The first and second camera modules 100 and 200 may be mounted on a rear surface of the portable electronic device 1. Although not illustrated in the drawings, the same or other types of camera modules may be mounted on a front surface of the portable electronic device 1.

The first camera module 100 described above may be a camera module according to an example embodiment of the present disclosure. Hereinafter, a camera module 100 according to an example embodiment of the present disclosure will be described in detail.

The camera module 100 according to an example embodiment of the present disclosure may be configured to allow an image of a subject at a long distance and an image of a subject at ultra-close distance to be captured.

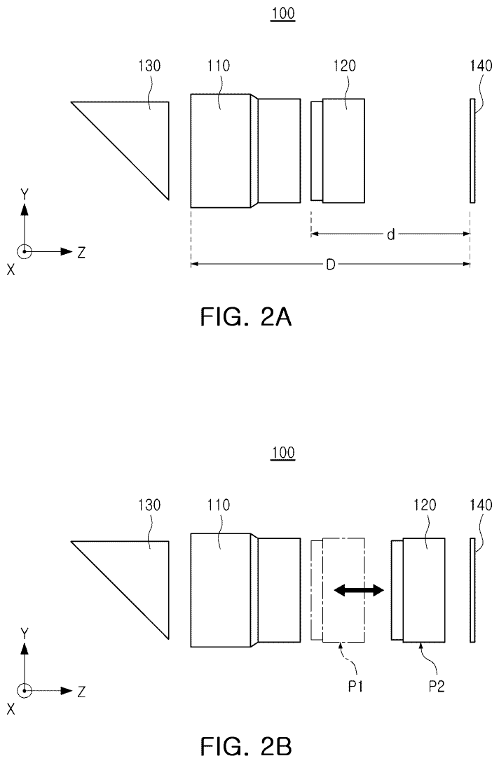

FIG. 2A is a schematic block diagram (infinite focus mode) of a camera module according to an example embodiment of the present disclosure. FIG. 2B is a schematic block diagram (macro focus mode) of a camera module according to an example embodiment of the present disclosure.

The camera module 100 according to an example embodiment of the present disclosure may include a plurality of lenses and a plurality of lens barrels 110 and 120 in which the plurality of lenses are mounted.

In an example embodiment, the camera module 100 may include a first lens barrel 110 and a second lens barrel 120. The first lens barrel 110 and the second lens barrel 120 may be disposed to be spaced apart from each other in an optical axis direction (Z-axis direction). According to another example embodiment, the camera module 100 may further include a third lens barrel (not illustrated) and the like.

In an example embodiment, a position of the first lens barrel 110 on the optical axis (Z-axis) may be fixed, and a position of the second lens barrel 120 on the optical axis (Z-axis direction) may vary. That is, the second lens barrel 120 may be moved in the optical axis direction (Z-axis direction), and may be moved from a position illustrated in FIG. 2A to a position illustrated in FIG. 2B when an image of a subject at ultra-close distance is captured. A detailed description thereof will be provided below.

In an example embodiment, the camera module 100 may include five or more lenses. The five or more lenses may be formed of a glass or plastic material. The five or more lenses may be divided into the first lens barrel 110 and the second lens barrel 120 and mounted in the optical axis direction (Z-axis direction).

A plurality of lenses, that is, at least two lenses, may be mounted in each of the first lens barrel 110 and the second lens barrel 120. A plurality of lenses, mounted in the first lens barrel 110, may form a first lens group LG1, and a plurality of lenses, mounted in the second lens barrel 120, may form a second lens group LG2. An optical axis (Z-axis) of the first lens group LG1 and an optical axis (Z-axis) of the second lens group LG2 may approximately correspond to each other.

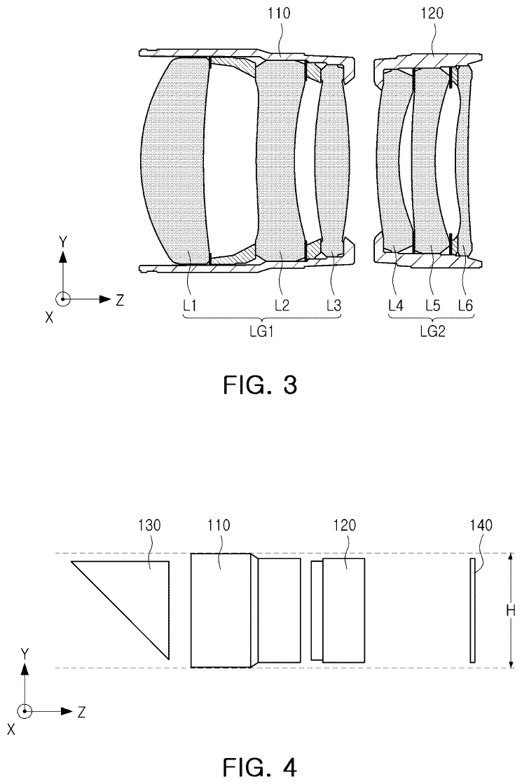

FIG. 3 is a diagram illustrating a configuration of a lens according to an example embodiment of the present disclosure.

As described above, the first lens group LG1 and the second lens group LG2 may be configured to include two or more lenses. In addition, the camera module 100 may include five or more lenses, such that one of the first lens group LG1 and the second lens group LG2 may include three or more lenses.

In the example embodiment illustrated in FIG. 3, each of the first lens group LG1 and the second lens group LG2 may include three lenses. The first lens group LG1 may include a first lens L1, a second lens L2, and a third lens L3, and the second lens group LG2 may include a fourth lens L4, a fifth lens L5, and a sixth lens L6. The first to sixth lenses L1 to L6 may be disposed in sequence from an object side.

The first to sixth lenses L1 to L6 may be disposed at predetermined intervals. To this end, at least one spacer may be disposed between two adjacent lenses. In detail, the spacer may be disposed between two adjacent lenses included in the same lens group, and may have a thickness varying depending on a predetermined interval between lenses.

With respect to an interval between the first lens group LG1 and the second lens group LG2, the first lens barrel 110 and the second lens barrel 120 may be disposed to be spaced apart from each other by a predetermined interval such that the first lens group LG1 and the second lens group LG2 have a predetermined interval therebetween. However, in an example embodiment of the present disclosure, the second lens barrel 120 may be provided to be movable in the optical axis direction (Z-axis direction), and thus the interval between the first lens group LG1 and the second lens group LG2 may be changed.

According to an example embodiment of the present disclosure, a distance on the optical axis from an object-side surface of a lens (for example, the fourth lens L4) of the second lens group LG2, disposed most adjacent to the object side, to an image-side surface of a lens (for example, the sixth lens L6) of the second lens group LG2, disposed most adjacent to an image side, may be shorter than a distance on the optical axis from an object-side surface of a lens (for example, the first lens L1) of the first lens group LG1, disposed most adjacent to the object side, to an image-side surface of a lens (for example, the third lens L3) of the first lens group LG1, disposed most adjacent to the image side. Accordingly, a length of the second lens barrel 120 in the optical axis direction (Z-axis direction) may be shorter than that of the first lens barrel 110 in the optical axis direction (Z-axis direction). In addition, lengths of the second lens barrel 120 in a height direction (Y-axis direction) and a width direction (X-axis direction) may be shorter than those of the first lens barrel 110 in the height direction (Y-axis direction) and the width direction (X-axis direction).

Referring back to FIGS. 2A and 2B, an image sensor 140 may be disposed on an image side of the second lens barrel 120. That is, the first lens barrel 110 may be disposed on an object side of the second lens barrel 120, and the image sensor 140 may be disposed on the image side of the second lens barrel 120.

The second lens barrel 120 may be moved in the optical axis direction (Z-axis direction) between the first lens barrel 110 and the image sensor 140. When an image of a subject at ultra-close distance is captured, the second lens barrel 120 may be moved from a first position P1 illustrated in FIG. 2A to a second position P2 illustrated in FIG. 2B.

According to an example embodiment of the present disclosure, a position of the first lens barrel 110 on the optical axis (Z-axis) may be fixed, such that a distance D from an object-side surface of the first lens barrel 110 to an imaging plane of the image sensor 140 may be always constant. Conversely, a position of the second lens barrel 120 on the optical axis (Z-axis) may vary according to a distance from a subject, such that a distance d from an object-side surface of the second lens barrel 120 to the imaging plane of the image sensor 140 may vary.

According to an example embodiment of the present disclosure, a plurality of lenses may be divided into a first lens group LG1 and a second lens group LG2, the divided lenses may be mounted in the first lens barrel 110 and the second lens barrel 120, respectively. Then, when an image of a subject is captured at an-ultra close distance, only the second lens barrel 120 may be moved to focus, thereby greatly reducing a moving distance of a lens group required for focus adjustment.

In addition, according to an example embodiment of the present disclosure, only the second lens barrel 120 may be moved in a state in which the position of the first lens barrel 110 on the optical axis (Z-axis) is fixed, such that an overall length of the camera module 100 may not be increased even when the camera module 100 has a macro function. Accordingly, the camera module 100 may have a reduced size.

In addition, the second lens barrel 120, moved during focus adjustment, may be smaller than the first lens barrel 110, such that focus adjustment may be performed with less driving force, and it can be advantageous in terms of driving stability.

In an example embodiment further including a third lens barrel, the third lens barrel may be moved in the optical axis direction (Z-axis direction), together with the second lens barrel 120, when an image of a subject is captured at ultra-close distance.

The camera module 100 according to an example embodiment of the present disclosure may further include an optical path converter 130 disposed on an object side of the first lens barrel 110. The optical path converter 130 may convert a path of light incident on the camera module 100 by about 90 degrees. In an example embodiment, the optical path converter 130 may convert a direction of traveling of light incident in the first axis direction (Y-axis direction) to the optical axis direction (Z-axis direction). For example, the optical path converter 130 may be a prism or a reflective surface such as a mirror.

The camera module 100 according to an example embodiment of the present disclosure may be a telephoto camera including the optical path converter 130. The telephoto camera may have a long focal length, such that a larger moving distance may be required for focus adjustment when an image of a subject is captured at ultra-close distance. However, according to an example embodiment of the present disclosure, only the second lens barrel 120 may be moved in a state in which the position of the first lens barrel 110 is fixed, thereby further reducing a moving distance.

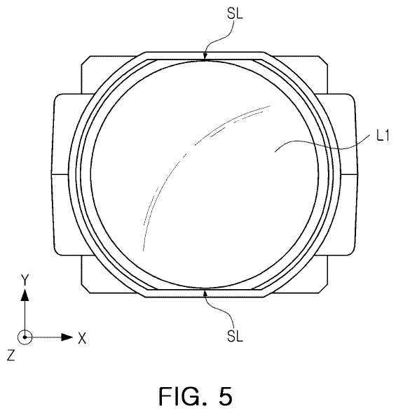

FIG. 4 is a diagram illustrating a height of a camera module according to an example embodiment of the present disclosure. FIG. 5 is a diagram illustrating an example embodiment in which a first lens is provided as a D-cut lens according to an example embodiment of the present disclosure.

The camera module 100 according to an example embodiment of the present disclosure may be mounted on the portable electronic device 1, such that a height direction of the camera module 100 may be parallel to a thickness direction of the portable electronic device 1 illustrated in FIG. 1. Accordingly, a reduction in size of the camera module 100 in the height direction (Y-axis direction) may be also useful according to slimming of the portable electronic device 1.

A height H of the camera module 100 may be determined by a height of the imaging plane of the image sensor 140 when a large-sized sensor is used, and a maximum diameter of a lens. Accordingly, in order to reduce a size of the camera module 100 in the height direction, at least one of a plurality of lenses may be provided as a D-cut lens.

In an example embodiment, the first lens L1, among a plurality of lenses, may have a largest diameter, and thus the first lens L1 may be provided as a D-cut lens having opposite sides in the height direction (Y-axis direction) being cut. The D-cut lens may refer to a lens having a straight line portion SL at an edge thereof due to a portion of the lens being cut.

In another example embodiment, at least one of the second to sixth lenses L2 to L6 may be a D-cut lens. In this case, the first lens L1 may or may not be a D-cut lens.

According to an example embodiment of the present disclosure, the first and second lens barrels 110 and 120 may be disposed in a housing (not illustrated). The housing may be a fixing member. The second lens barrel 120 may be provided to be movable in the optical axis direction (Z-axis direction), such that the second lens barrel 120 may be movably supported by the housing. Conversely, a position of the first lens barrel 110 on the optical axis (Z-axis) may be fixed, such that the first lens barrel 110 may be disposed in the housing in a state of being structurally coupled to the housing.

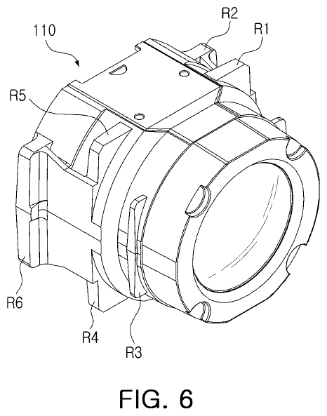

FIG. 6 is an example diagram illustrating a first lens barrel according to an example embodiment of the present disclosure.

According to an example embodiment of the present disclosure, the first lens barrel 110 may be structurally coupled to the housing through rib surfaces R1 to R6. The first lens barrel 110 may have a plurality of rib surfaces, thereby increasing a contact area between the first lens barrel 110 and the housing, and improving coupling force therebetween. The first lens barrel 110 may preferably have four or more rib surfaces. In an example embodiment, at least a left upper end, a right upper end, a left lower end, and a right lower end of the first lens barrel 110 may have rib surfaces, respectively. The number and positions of the rib surfaces illustrated in FIG. 6 are merely examples, and some rib surfaces may be omitted or may be additionally provided at other positions.

In an example embodiment of the present disclosure, a plurality of lenses, included in the first lens group LG1, may be mounted in the first lens barrel 110, and at least one of the plurality of lenses may be a glass material. As described above, even when a weight of the first lens barrel 110 itself increases due to a lens formed of a glass material, the first lens barrel 110 may be coupled to the housing through a plurality of rib surfaces R1 to R6, such that sufficient coupling force may be secured. Thus, the first lens barrel 110 may be stably coupled to the housing.

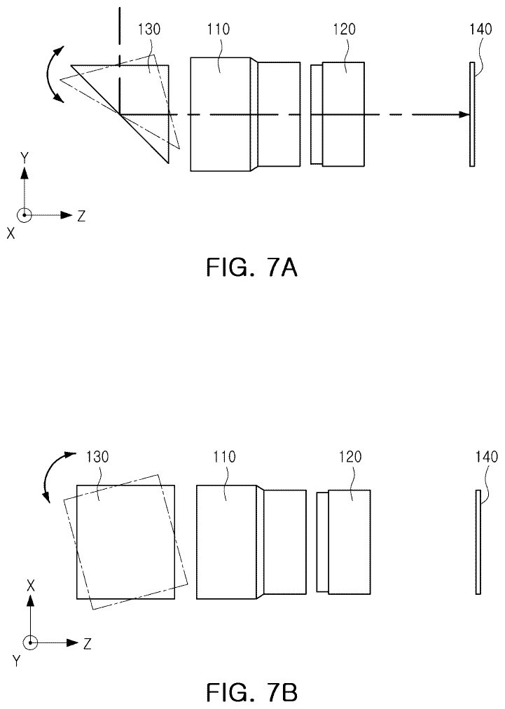

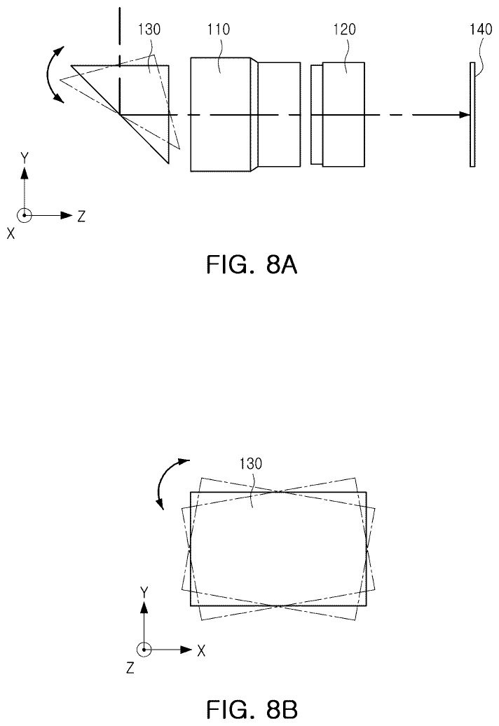

FIGS. 7A and 7B are example diagrams illustrating driving of an optical path converter of a camera module according to an example embodiment of the present disclosure. FIGS. 8A and 8B are example diagrams illustrating driving of an optical path converter of a camera module according to another example embodiment of the present disclosure.

According to an example embodiment of the present disclosure, a focus adjustment function of the camera module 100 may be implemented by moving the second lens barrel 120 in the optical axis direction (Z-axis direction), and an image stabilization function may be implemented by rotating the optical path converter 130 about two axes.

In an example embodiment, the optical path converter 130 may be rotated using a first axis (Y-axis) perpendicular to the optical axis (Z-axis), and a second axis (X-axis) perpendicular to the first axis (Y-axis), as rotational axes. When the optical path converter 130 is rotated about the first axis (Y-axis) and the second axis (X-axis), an interval between the optical path converter 130 and the first lens barrel 110 may decrease. Accordingly, in order to prevent collision between the optical path converter 130 and the first lens barrel 110 during rotation of the optical path converter 130, the first lens barrel 110 may be disposed to have a sufficient interval from the optical path converter 130.

Alternatively, in another example embodiment, the optical path converter 130 may be rotated using an optical axis (Z-axis) and a second axis (X-axis) perpendicular to the optical axis (Z-axis), as rotational axes.

A camera module according to an example embodiment of the present disclosure may reduce an amount of movement when an image of a subject is captured at ultra-close distance. Accordingly, the camera module may have a reduced size.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a first lens group comprising a plurality of lenses and disposed fixedly on an optical axis; and
a second lens group comprising a plurality of lenses and movable in an optical axis direction,
wherein the first lens group and the second lens group are disposed in sequence from an object side, and
wherein a distance on the optical axis from an object-side surface of a lens of the second lens group, disposed closest to the object side, to an image-side surface of a lens of the second lens group, disposed closest to an image side, is shorter than a distance on the optical axis from an object-side surface of a lens of the first lens group, disposed closest to the object side, to an image-side surface of a lens of the first lens group, disposed closest to the image side.

2. The camera module of claim 1, further comprising:
an image sensor disposed on the image side of the second lens group,
wherein the second lens group is configured to be movable in the optical axis direction between the first lens group and the image sensor.

3. The camera module of claim 1, wherein an optical axis of the first lens group and an optical axis of the second lens group approximately correspond to each other.

4. The camera module of claim 1, wherein the first lens group is accommodated in a first lens barrel, and the second lens group is accommodated in a second lens barrel.

5. The camera module of claim 1, further comprising:
an optical path converter disposed on the object side of the first lens group.

6. The camera module of claim 5, wherein the optical path converter is configured to be rotatable about one or more of the optical axis, a first axis perpendicular to the optical axis, and a second axis perpendicular to both the optical axis and the first axis.

7. The camera module of claim 1, further comprising:
a third lens group comprising a plurality of lenses and movable in an optical axis direction,
wherein the third lens group is disposed on the image side of the second lens group.

8. The camera module of claim 1, wherein one or more of the first lens group and the second lens group includes a D-cut lens having a straight portion on an edge thereof.

9. The camera module of claim 1, wherein one or more of the first lens group and the second lens group includes three or more lenses.

10. A portable electronic device comprising:
the camera module of claim 1,
wherein the optical axis direction is perpendicular to a thickness direction of the portable electronic device.

11. A portable electronic device comprising:
a plurality of camera modules having different optical characteristics from each other,
wherein the plurality of camera modules comprises the camera module of claim 1.

12. A camera module comprising:
a first lens group including some lenses, among five or more lenses arranged in an optical axis direction, and a second lens group including the remaining lenses,
wherein the second lens group is configured to be movable relative to the first lens group in the optical axis direction, and
a distance on the optical axis from an object-side surface of a lens of the second lens group, disposed closest to an object side, to an image-side surface of a lens of the second lens group, disposed closest to an image side, is shorter than a distance on the optical axis from an object-side surface of a lens of the first lens group, disposed closest to the object side, to an image-side surface of a lens of the first lens group, disposed closest to the image side.

13. The camera module of claim 12, wherein each of the first lens group and the second lens group includes two or more lenses.

14. The camera module of claim 12, wherein the first lens group is disposed on the object side of the second lens group, and an image sensor is disposed on the image side of the second lens group.

15. The camera module of claim 12, further comprising:
an optical path converter disposed on the object side of the first lens group.

16. The camera module of claim 12, wherein one or more of the five or more lenses includes a D-cut lens having a straight portion on an edge thereof.

17. The camera module of claim 12, wherein the five or more lenses are formed of a glass or plastic material.

18. The camera module of claim 12, further comprising:
a first lens barrel in which the first lens group is mounted;
a second lens barrel in which the second lens group is mounted; and
a housing in which the first lens barrel and the second lens barrel are accommodated,
wherein the first lens barrel has a plurality of rib surfaces coupled to the housing.

19. A portable electronic device comprising:
the camera module of claim 12,
wherein the optical axis direction is perpendicular to a thickness direction of the portable electronic device.

20. A portable electronic device comprising:
a plurality of camera modules having different optical characteristics from each other,
wherein the plurality of camera modules comprises the camera module of claim 12.
